(19) United States
(12) Patent Application Publication
(10) Pub. No.: US 2009/0188587 A1
(43) Pub. Date: Jul. 30, 2009

(54) Multiple Router Device for Simultaneously Cutting Multiple Edges

(76) Inventor: Gary Geisel, Capistrano Beach, CA (US)

Correspondence Address: ERIC HANSCOM, 7395 PORTAGE WAY, CARLSBAD, CA, 92011, US

(21) Appl. No.: 12/359,337

(22) Filed: Jan. 25, 2009

Related U.S. Application Data
(60) Provisional application No. 61/023,488, filed on Jan. 25, 2008.

(51) Int. Cl. B27C 9/04; B27C 9/00

(52) U.S. Cl. 144/371; 144/1.1

(57) ABSTRACT

A device that includes a plurality of routers, where the plurality of routers are independently positioned and can be placed in various orientations relative to the object being cut. The plurality of routers can be mounted on the same side, opposite side, or at any angle in between. The plurality of routers can also be positioned in three dimensions such that many different cuts can be made at the same time on objects of various shapes and sizes. Further, each router is easily removed from the device for handheld use, yet easily reattached to the device such that the router is returned to the same position it was in before removal. This creates a device that can make multiple cuts from multiple angles on objects of various shapes and sizes during one pass through the device.

### CROSS REFERENCE TO RELATED APPLICATIONS

This application is a non-provisional application of U.S. Provisional Patent Application Number 61/023,488 filed on Jan. 25, 2008.

### STATEMENT REGARDING FEDERALLY SPONSORED RESEARCH OR DEVELOPMENT

This invention was not federally sponsored.

### BACKGROUND OF THE INVENTION

### FIELD OF THE INVENTION

This invention relates to the general field of cutting devices, and more specifically toward a device that comprises a plurality of routers, where the plurality of routers are independently positioned and can be placed in various orientations relative to the object being cut. It is a standalone device that provides good visibility of the object being cut by the user. The plurality of routers can be mounted on the same side, opposite sides, or at any angle in between. The plurality of routers can also be positioned in three dimensions such that many different cuts can be made at the same time on objects of various shapes and sizes. Further, each router is easily removed from the device for handheld use, yet easily reattached to the device such that the router is returned to the same position it was in before removal. This creates a device that can make multiple cuts from multiple angles on objects of various shapes and sizes during one pass through the device.

A router has traditionally been a woodworking tool to cut grooves, edge molding, or chamfer a particular edge of a piece of wood. The original hand powered router had a broad-based wooden hand plane with a blade that projected beyond the hand plane. The first electric router appeared on the markets after World War 1. The modern spindle router, which uses a motor to rotate a cutting blade, appeared around the 1960s.

Mounting routers onto a device is known in the prior art. Further, devices are known that also contain multiple routers on a single device such that multiple cuts can be made on a single object on a single pass through the device. However, the prior art has not disclosed a device that includes multiple routers where the routers can be adjusted horizontally and vertically as well as into different orientations to cut a wide variety of sized and shaped objects. The prior art also does not disclose such a device where the routers can be quickly and easily removed from the device for handheld use, and then quickly and easily reattached to the device in the same position that they were in before.

There are occasions where it is beneficial to use a router by hand, such as on small jobs or irregular shaped pieces that must be cut by hand. However, a quality router can cost upwards of two-hundred dollars or more. This makes purchasing a router for handheld use in addition to routers used in the current invention a costly investment. Therefore, it is a cost-effective use of tools when one or more routers from the current invention can be removed from the device and used by hand, thereby alleviating the requirement of purchasing an additional router for handheld use. Further, reducing the number of routers required for a job site also reduces the amount of weight that must be transported to a job site, as routers can weigh ten pounds or more. Carpenters can also grow accustomed to their tools, learning their specific quirks and nuances that allow a carpenter to quickly and efficiently use that tool. By allowing the same router to be used in multiple applications, a user of the current invention need not grow accustomed to other tools of similar type. Thus, it is beneficial if the routers used in a device to make multiple concurrent cuts on an object can also be removed from the device and used individually by the user, thereby reducing the number of tools required by the user to perform a specific job.

Thus there has existed a long-felt need for a device with multiple routers that can make multiple simultaneous cuts on an object, where the object can be of various shapes and sizes. The routers should be easily adjusted into a variety of positions to easily and effectively make a wide range of cuts on the object. The routers should be easily removed from the device so they can be used by hand if desired by the user. The routers should then be able to be returned to the device into the same position they were in before.

The current invention provides just such a solution by having a device that comprises a plurality routers, where the two or more routers are independently positioned and can be placed in various orientations relative to the object being cut. It is a standalone device that provides good visibility of the object being cut by the user. The plurality of routers can be mounted on the same side, opposite sides, or at any angle in between. The plurality of routers can also be positioned in three dimensions such that many different cuts can be made at the same time on objects of various shapes and sizes. Further, each router is easily removed from the device for handheld use, yet easily reattached to the device such that the router is returned to the same position it was in before removal. This creates a device that can make multiple cuts from multiple angles on objects of various shapes and sizes.

### SUMMARY OF THE INVENTION

The current invention is a device for cutting an object, such as a length of wood, using a plurality of routers, preferably fixed-base routers. A table like platform is used to support the object to be cut. A guide rail along one side of the table is used to position the object to be cut as it is slid through the device. As the object is slid through the device, it passes by the plurality of routers, where each router is used to cut a portion of the object along its length. By adjusting the routers horizontally and vertically, different sized objects can be cut. Further by changing the orientation of the router, for example having one above the table and one below the table, cuts from different angles can be made on the object. If the user needs to use one or more of the routers manually, the routers can quickly and easily be removed. After the manual use of the router, the user can quickly and easily reattach the router to the device such that it is in exactly the same position as it was before the router was removed from the device.

It is a principal object of the invention to provide a device for making multiple simultaneous cuts on an object as it is passed through the device.

It is another object of the invention to provide a device that has a plurality of routers that are easy to adjust into different positions and orientations.

It is a further object of this invention to provide a device that can make multiple simultaneous cuts on objects of many different sizes.

It is an additional object of this invention to provide a device where the routers can be adjusted to make cuts in an object from various different angles.

It is a final object of this invention to provide a device where the routers can easily be removed from the device for manual use, and then reattached to the device such that the router is quickly and easily returned to its original position before it was removed.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE FIGURES

FIG. 1 is a perspective view of an embodiment of the current invention with two routers oriented in opposite directions.

FIG. 2 is a front view of the embodiment of the current invention with two routers oriented in opposite directions.

FIG. 3 is a top view of the embodiment of the current invention with two routers oriented in opposite directions.

FIG. 4 is a bottom view of the embodiment of the current invention with two routers oriented in opposite directions.

FIG. 5 is a side view of the embodiment of the current invention with two routers oriented in opposite directions.

FIG. 6 is an opposite side view of the embodiment of the current invention with two routers oriented in opposite directions.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings.

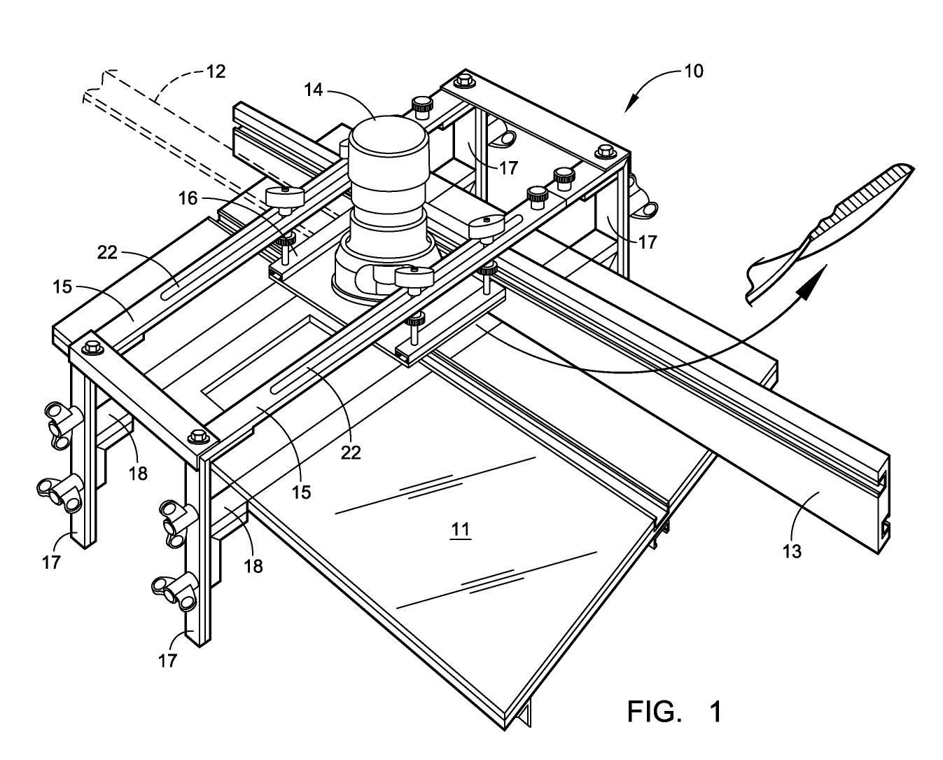

FIG. 1 is a perspective view of an embodiment of the current invention with two routers oriented in opposite directions. The device 10 includes a table 11 on which to rest an object 12 being cut, as shown by dashed lines, with a guide rail 13 to guide the object 12 through the device 10 as it is being cut. The table 11 is supported on two lower rails 18, which in turn are attached to four legs 17. The height of the lower rails 18, and therefore the height of the table 11, can be adjusted. Also attached to the legs 17 are two upper rails 15. These two upper rails 15 have slots 22 to slide an upper router base unit 16. The upper router base unit 16 is used to support and attach the upper router 14 above the table 11. The height of the upper router base unit 16, and therefore the upper router 14, can be adjusted. A lower router (not shown in this figure) can be secured directly to the underside of the table 11, such that the lower router is inverted relative to the upper router. The combination of the two routers provides the ability to make multiple cuts on a single object, such as wood, by running it once through the device. An exemplary cut object 21 is shown in this figure, where the two routers have made multiple cuts during a single pass through the device. Various knobs are used to make adjustments on the device, such as to adjust the positions of the table, routers, or guide rail.

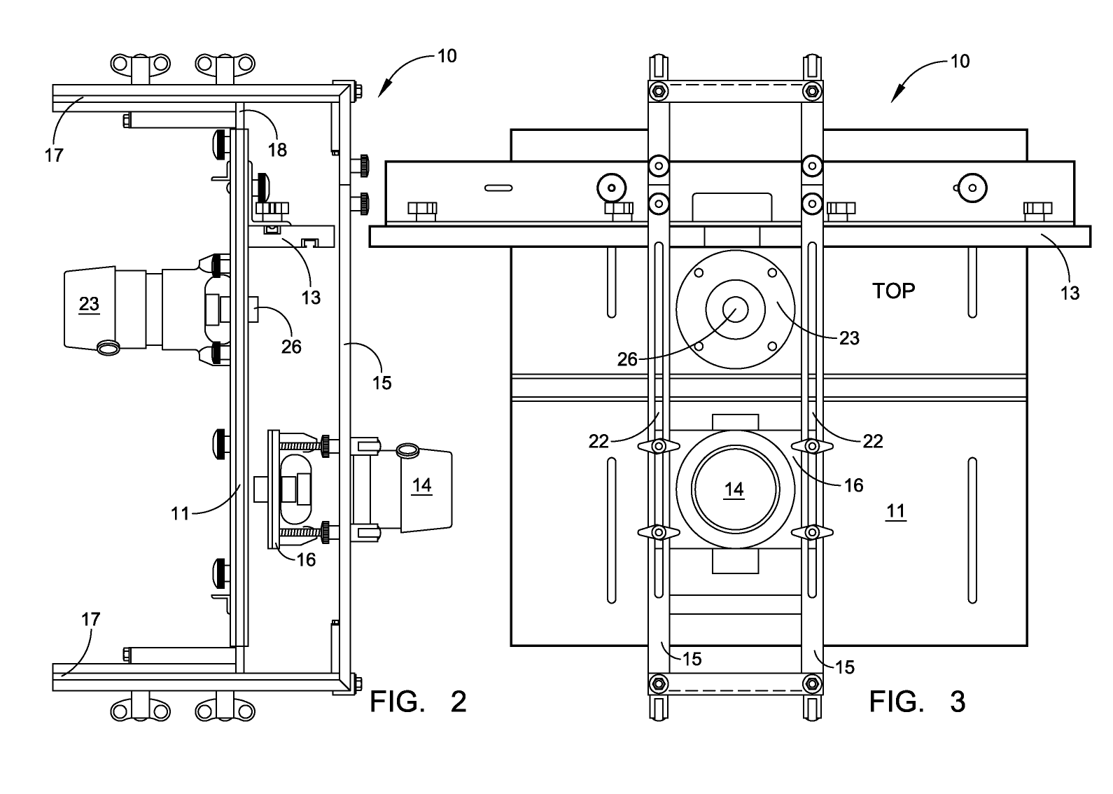

FIG. 2 is a front view of the embodiment of the current invention with two routers oriented in opposite directions. The device 10 includes a table 11 on which to rest an object being cut. A guide rail 13 is shown connected to the table 11 such that the guide rail 13 is perpendicular to the table 11. The guide rail 13 can be adjusted such that the object to be cut is moved closer or further away from the routers. A lower router 23 is attached to the table 11. The lower router 23 can be raised or lowered relative to the table 11. Lower rails 18 support the table 11 and are connected to legs 17 of the device. Upper rails 15 are also connected to the legs 17. An upper router base unit 16 can attach to and slide along the upper rails 15. An upper router 14 is secured to the upper router base unit 16, and can be adjusted closer to or further away from the table 11. The upper router 14 and lower router 23 are oriented in opposite directions such that the cutting tools 26 of each router can make a cut on a different side of an object passing through the device 10.

FIG. 3 is a top view of the embodiment of the current invention with two routers oriented in opposite directions. A lower router 23 is facing up while the upper router 14 is facing down. The upper router 14, attached to a base unit 16, is secured to two upper rails 15 with slots, which allows the upper router 14 to slide along the upper rails 15. A guide rail 13 can be used to guide an object on top of the table 11 through the device 10 as it is being cut.

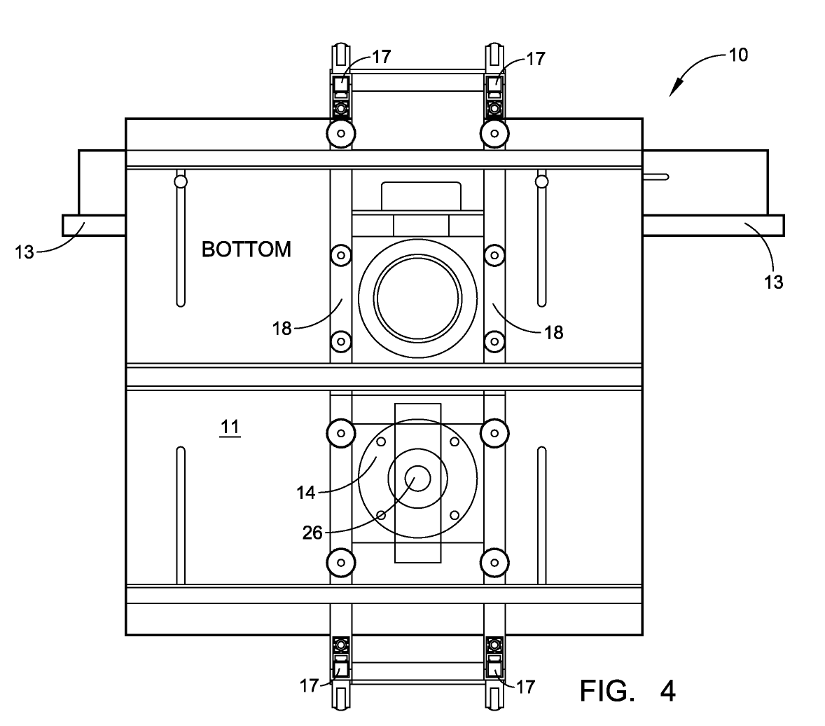

FIG. 4 is a bottom view of the embodiment of the current invention with two routers oriented in opposite directions. In this view, the bottom of the table 11 is seen with the lower router 23 facing away and the upper router 14 facing toward the viewer. A guide rail 13 is shown extending beyond either side of the table 11.

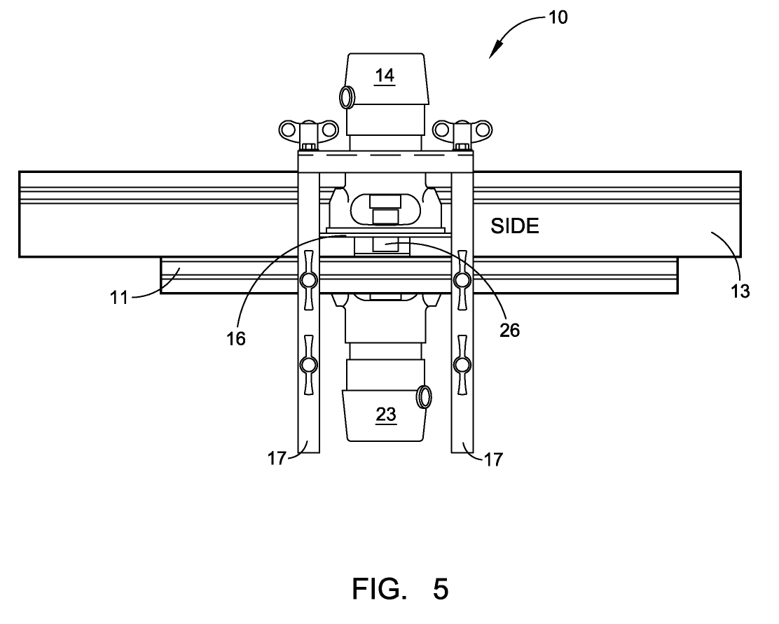

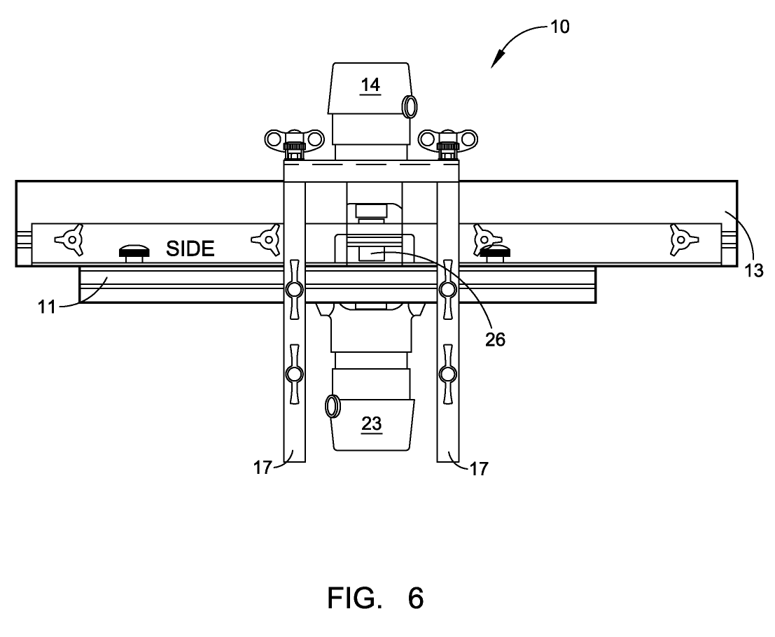

FIG. 5 and FIG. 6 are side views of the embodiment of the current invention with two routers oriented in opposite directions. The legs 17 of the device 10 support, via two lower rails, a table 11, which in turn supports a guide rail 13. A lower router 23 is positioned below the table 11 such that the cutting tool of the lower router 23 is facing upward through the table 11. The table 11 should be located high enough such that the legs 17 and not the lower router 23 support the device 10 when placed on a flat, even surface. An upper router 14 is supported by upper rails that connect to the legs 17 of the device 10. The cutting tools 26 of the upper router 14 and the lower router 23 face each other and are used to cut objects that are slid through the device 10. Various knobs are used to make adjustments on the device, such as to adjust the positions of the table, routers, or guide rail.

While one particular embodiment of the invention has been disclosed herein, many possible variations are possible without departing from the scope of the invention. Many different materials can be cut using the device of the current invention. Wood may be the most common material cut with this device, but any type of material appropriate for being cut by a router can be cut by this device, including metal, plastic, and stone.

Further, more than two routers are contemplated for use with the device. For example, and additional router may be attached to the top rails, such that two routers are located above the table and proximate to each other. Additional legs and top rails can also be used to add any number of additional routers. Any number of bottom routers can also be attached to the device by securing them to the table. The routers can be situated such that cuts are made at the same point as the object is being passed through the device. It is also possible that the routers be positioned in series, such that cuts are consecutively made as the object is passed through the device. This could be beneficial where multiple routers are required to make consecutive cuts on the same portion of the object to create the desired shape.

The various routers used in the device can also be oriented at different angles. For example, the upper router base unit can be adjusted such that the upper router is not perpendicular to the table. It can be angled about an axis that runs along the length of the table, the width of the table, or both, such that virtually any cutting angle required to cut the object into the desired shape is achievable with the device of the current invention. The varied cutting angle can be achieved by varying the length of attachment points from the base unit to the rails. As seen in FIG. 1, the base unit 16 is connected to the upper rails 15 by four long attachment screws with wing nuts (or knobs). By varying the location of the wing nuts along the length of the screw, the attachment length of the screw is varied. By unevenly varying the attachment lengths of each of the screws, the angle of the router can be varied. Note that by changing the attachment length of the screws evenly, the height of the router relative to the table can be varied. The different orientations of the routers enables a user to make simultaneous cuts on a single object from different angles. This unprecedented ability can be used to quickly and efficiently create more complex routing cuts.

The device can also include motorized means to move the object being cut through the device. This feature not only has the benefit of added safety to the user since arms, hands, and legs can remain at a safe distance from any cutting tools, but it can also create more consistent cuts on a single object and among many objects to be cut in the same way. Other means are also possible to pass the object being cut through the device, including the use of magnets when the object being cut comprises a ferrous metal.

The current invention can be powered in various ways. Each router or other cutting tool can have its own power cable and be plugged directly into an outlet. Alternatively, each cutting tool can be plugged into a central power strip located on the device, and then the device itself can be plugged into a power outlet. In addition to the cutting tools, lights, speakers, or other accessories that may require power can be plugged into the device.

Other types of cutting tools can be included with the device, in addition to or in place of the routers. One or more saws could be used to cut the object, preferably after passing by the routers. A drill could be used to drill holes into the object at set distances along the length of the object. Additionally, other materials can be applied to the object before or after passing through any cutting tools of the device. For example, paint can be sprayed onto the object from various angles before or after being cut.

A means of quick release and attachment can be used to secure the routers to the base units. The means of quick release and attachment include mating pairs such as a screw wing nut combination, magnets, hook and loop fasteners, and other means well known in the art. When a screw wing nut combination is used, it may be preferable to include additional nuts such that the router can easily be returned to its previous position after manual use. When magnets are used to secure the router to the base unit, grooves or uneven surfaces are preferably, such that the router is easily pulled away from the base unit, but not easily moved parallel to the base unit. One or more mating pairs can be used to secure one router to one base unit. While a means of quick release may be preferable, it is nonetheless possible to permanently secure the router to the base unit.

The current invention is a truly beneficial device that enables a user to make multiple cuts on a single object in a single pass through the device. Multiple routers can be used in various different positions and orientations to create a wide variety of desired cuts. Each router can also be easily removed from the device for handheld use, and then returned to its originally location in its original orientation.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A device for making multiple cuts on an object as it passes through the device comprising:
a plurality of routers, a table, and four or more legs,
where the plurality of routers make cuts on the object as it is passed through the device, where the four or more legs support the device.

2. The device of claim 1, further comprising a guide rail.

3. The device of claim 2, where the guide rail is located on top of the table.

4. The device of claim 1, where at least one of the plurality of routers is in a different orientation than any of the other routers.

5. The device of claim 1, where at least one of the plurality of routers is in an opposite orientation from another of the plurality of routers.

6. The device of claim 1, where the device comprises three or more routers.

7. The device of claim 1, where the device further comprises a saw.

8. The device of claim 1, further comprising two or more lower rails, where the two or more lower rails are attached to the four or more legs, where the two or more lower rails support the table.

9. The device of claim 8, where the two or more lower rails are removably attached to the four or more legs.

10. The device of claim 1, further comprising two or more upper rails, where the two or more upper rails are attached to the four or more legs, where the two or more upper rails support at least one of the plurality of routers.

11. The device of claim 10, where the two or more upper rails are removably attached to the four or more legs.

12. The device of claim 11, further comprising a base unit, where the router supported by the two or more upper rails is removably secured to the base unit, where the base unit is attached to the two or more upper rails.

13. A device for making multiple cuts on an object as it passes through the device comprising:
a plurality of routers, a table, four or more legs, two or more upper rails, and two or more lower rails,
where the plurality of routers make cuts on the object as it is passed through the device, where the four or more legs support the device, where the two or more lower rails are attached to the four or more legs, where the two or more lower rails support the table, where the two or more upper rails are attached to the four or more legs, where the two or more upper rails support at least one of the plurality of routers.

14. The device of claim 13, further comprising a guide rail, where the guide rail is located on top of the table.

15. The device of claim 13, where at least one of the plurality of routers is in a different orientation than any of the other routers.

16. The device of claim 13, where at least one of the plurality of routers is in an opposite orientation from another of the plurality of routers.

17. The device of claim 13, where the two or more lower rails are removably attached to the four or more legs, and where the two or more upper rails are removably attached to the four or more legs.

18. The device of claim 13, further comprising a base unit, where the router supported by the two or more upper rails is removably secured to the base unit, where the base unit is attached to the two or more upper rails.

19. A method for making multiple cuts on an object comprising:
obtaining a cutting device, where the cutting device comprises a plurality of routers, a table, four or more legs, a guide rail, two or more upper rails, and two or more lower rails, where the plurality of routers make cuts on the object as it is passed through the device, where the four or more legs support the device, where the two or more lower rails are attached to the four or more legs, where the two or more lower rails support the table, where the two or more upper rails are attached to the four or more legs, where the two or more upper rails support at least one of the plurality of routers, and where the guide rail is located on top of the table;
adjusting the plurality of routers such that at least one of the routers is in a different orientation from the other routers;
adjusting the height of the table, the position of one or more of the plurality of routers, or both; and
sliding the object through the cutting device along the top of the table such that the plurality of routers make cuts on the object.

20. The method of claim 19, further comprising the steps of:
adjusting at least one of the plurality of routers to a different orientation, adjusting at least one of the plurality of routers to a different position, or both;
sliding another object through the cutting device along the top of the table such that the plurality of routers make cuts on the object.
